(19) United States
(12) Patent Application Publication
(10) Pub. No.: US 2009/0311560 A1
(43) Pub. Date: Dec. 17, 2009

(54) Method for reverse activation of fuel cell

(75) Inventors: Keun Je Lee, Gyeonggi-do (KR); Kook II Han, Seoul (KR)

Correspondence Address: EDWARDS ANGELL PALMER & DODGE LLP, P.O. BOX 55874, BOSTON, MA, 02205, US

(73) Assignees: Hyundai Motor Company, Seoul (KR); Kia Motors Corporation, Seoul (KR)

(21) Appl. No.: 12/283,459

(22) Filed: Sep. 11, 2008

(30) Foreign Application Priority Data
Jun. 12, 2008 (KR) 10-2008-0055009

(51) Int. Cl. H01M 8/04

(52) U.S. Cl. 429/13

(57) ABSTRACT

The present invention provides a method for reverse activation of a fuel cell, which can improve fuel cell performance by performing a first fuel cell activation process and then performing a second fuel cell activation process in which a hydrogen inlet and a hydrogen outlet of the fuel cell are shifted to an air (or oxygen) inlet and an air (or oxygen) outlet of the fuel cell.

### CROSS-REFERENCE TO RELATED APPLICATION

This application claims under 35 U.S.C. §119(a) the benefit of Korean Patent Application No. 10-2008-0055009 filed Jun. 12, 2008, the entire contents of which are incorporated herein by reference.

### BACKGROUND

(a) Technical Field

The present invention relates to a method for reverse activation of a fuel cell which can improve fuel cell performance.

(b) Background Art

A fuel cell is a device that generates electrical energy by electrochemically converting chemical energy of a fuel directly into electrical energy and includes a membrane electrode assembly (MEA).

The MEA includes a fuel electrode (anode) to which hydrogen is supplied, an air electrode (cathode) to which air is supplied, and an electrolyte membrane interposed between the fuel electrode and the air electrode for transporting hydrogen ions. A fuel cell stack is formed by sequentially stacking the MEA and a separator.

When hydrogen as a fuel is supplied to the fuel electrode and oxygen as an oxidant is supplied to the air electrode, the hydrogen supplied to the fuel electrode is dissociated into hydrogen ions and electrons by an oxidation reaction on the catalyst layer disposed on the fuel electrode. Then, the thus generated hydrogen ions move to the air electrode through the electrolyte membrane and the electrons are transferred to the air electrode through an external circuit. As a result, at the air electrode, the supplied oxygen combines with electrons to produce oxygen ions by a reduction reaction on the catalyst layer disposed on the air electrode, and the hydrogen ions combine with the oxygen ions to produce water, thus generating electricity.

In case of a newly fabricated fuel cell stack having the above-described configuration and principle of electricity generation, the degree of activation in the electrochemical reaction is deteriorated during initial operation. Accordingly, in order to achieve the best performance during initial operation, an activation process, also called pre-conditioning or break-in process, is usually performed.

One primary object of the activation process is to activate the catalyst having no or low catalytic activity and ensure a hydrogen ion transfer path by sufficiently hydrating the electrolyte contained in the electrolyte membrane and the electrodes.

The performance of the fuel cell is determined by the electrochemical characteristics such as ionization of hydrogen and oxygen in the electrodes according to the catalyst activity and mobility of the generated ions (H+ and O2−) and electrons.

When the initial operation of the newly fabricated fuel cell stack is performed without the activation process, the following problems may occur.

First, the distribution of the triple phase boundary between the electrolyte membrane, the catalyst layers of the electrodes (fuel electrode and air electrode), and the reactant gases (hydrogen and air) is inefficient, and thus the active site may be restricted and the transfer paths of the reactants may be closed or isolated.

Second, an oxidation film is formed on the electrode catalyst layers, and thus the catalyst efficiency and the electron conductivity may be reduced.

Third, the electrolyte membrane is not sufficiently hydrated, and thus the mobility of hydrogen ions is reduced, which results in unstable and low performance of the fuel cell.

In one prior art process of fuel cell activation, humidification and load cycle are applied to the fuel cell. In more detail, the electrode reaction is induced in the triple phase boundary and the electrolyte membrane is sufficiently hydrated by supplying reactant gases such as hydrogen and air (or oxygen) to a hydrogen inlet and an air (or oxygen) inlet of the fuel cell, respectively.

The prior art process, however, has a drawback. In case where the separator in the fuel cell stack is long, a difference in fuel (hydrogen) concentration occurs, which causes a difference in catalyst activity. As a result, there occurs a difference in performance of the left and right sides of the MEA, and thus it is impossible to achieve the maximum performance of the fuel cell.

That is, as shown in FIG. 2, measurement of the fuel concentration of the separator after completion of the fuel cell activation shows there occurred a difference in the fuel concentration at the left and right sides of the separator in the longitudinal direction thereof, which causes a difference in the performance of the left and right sides of the MEA, and thus it is impossible to achieve the maximum performance of the fuel cell.

The difference in the fuel concentration according to the length of the separator occurs because while the amounts of the fuel (hydrogen) and the air (or oxygen) supplied per hour are constant and the differential pressure applied to the separator is also constant, the fuel (hydrogen) and the air (or oxygen) are consumed as they pass through flow paths of the separator although and the fuel concentration is thus reduced at the rear end.

The difference in the fuel concentration causes a difference in the catalyst activity at the left and right sides of the MEA. That is, the catalyst is highly activated at a position where the fuel concentration is high and the catalyst is not sufficiently activated at a position where the fuel concentration is low. Moreover, the low concentration is continuously maintained even after the activation process.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art. Accordingly, the present invention provides a method for reverse activation of a fuel cell, which can improve performance of the fuel cell by making uniform the concentration distribution of fuel (hydrogen) and air (or oxygen) of a fuel cell separator.

In one aspect, the present invention provides a method for reverse activation of a fuel cell in two processes. In the first activation process, a predetermined amount of hydrogen and oxygen containing air (or oxygen) is supplied to a hydrogen inlet and an air (or oxygen) inlet of a fuel cell, respectively, and hydrogen and air (or oxygen) after electrochemical reaction are discharged through a hydrogen outlet and an air (or oxygen) outlet. In the second activation process, the same method as used in the first step is performed while using the hydrogen and air (or oxygen) inlets as hydrogen and air (or oxygen) outlets and the hydrogen and air (or oxygen) outlets as hydrogen and air (or oxygen) inlets.

That is, in the first fuel cell activation process, hydrogen and air (or oxygen) are supplied to a hydrogen inlet and an air (or oxygen) inlet of a fuel cell and, in the second fuel cell activation process, which is a reverse activation process, hydrogen and air (or oxygen) are supplied to a hydrogen outlet and an air (or oxygen) outlet of the fuel cell.

In a preferred embodiment, the respective activation processes are performed by the following order: (i) mounting the fuel cell in equipment for activation; (ii) changing the state of a humidifier for supplying water vapor steam to the fuel cell and the state of coolant; (iii) supplying hydrogen and oxygen containing air (or pure oxygen) to the fuel cell and operating the fuel cell under no-load condition; (iv) operating the fuel cell under load condition by varying the amount of hydrogen and air (or oxygen) supplied to the fuel cell; (v) returning the operation condition of the fuel cell to the no-load condition and resupplying reactant gases; and (vi) determining whether activation is completed by comparing data measured when the fuel cell is operated under no-load condition with data measured when the fuel cell is operated under load condition.

After the first activation process, the hydrogen concentration along the longitudinal direction of a separator of the fuel cell is not uniform. That is, the hydrogen concentration at the hydrogen inlet side of the fuel cell is high and the air (or oxygen) concentration is low, and the hydrogen concentration at the hydrogen outlet side is low and the air (or oxygen) concentration is high.

The second activation process offsets the hydrogen concentration and air (or oxygen) concentration resulted from the first activation step to make the hydrogen concentration uniform along the longitudinal direction of the fuel cell separator.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram illustrating a method for reverse activation of a fuel cell in accordance with the present invention;

FIG. 2 is a graph showing a concentration distribution of hydrogen in a separator measured after performing a conventional fuel cell activation method; and

FIG. 3 is a graph comparing the conventional fuel cell activation process and the present fuel cell activation in terms of the fuel cell performance.

Reference numerals set forth in the Drawings includes reference to the following elements as further discussed below:

| | |
|---|---|
| 10: fuel cell stack | 12a: hydrogen inlet |
| 12b: hydrogen outlet | 14a: air (or oxygen) inlet |
| 14b: air (or oxygen) outlet | 20: separator |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

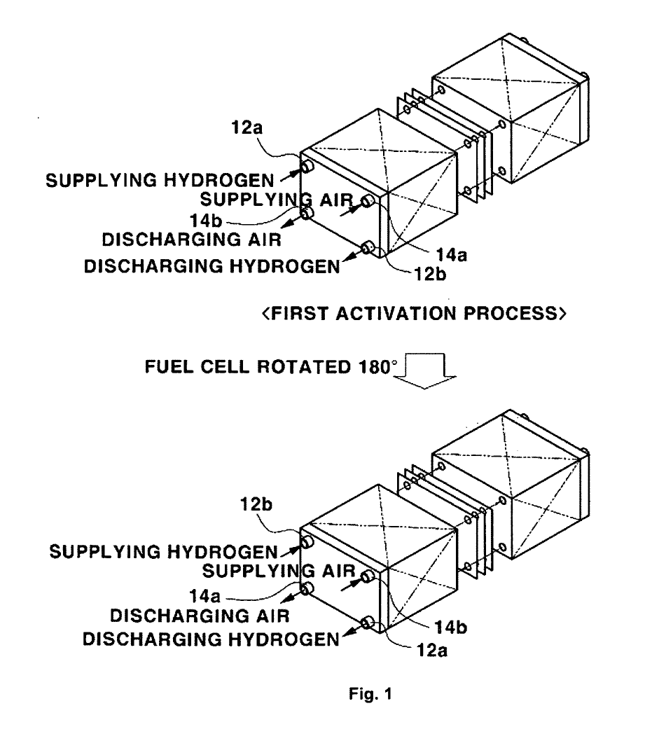

The fuel cell reverse activation process according to an embodiment of the present invention is described referring to FIG. 1.

A fuel cell stack 10 is mounted in equipment for activation of a fuel cell (not shown). Reactant gases such as hydrogen and oxygen containing air (or pure oxygen) are supplied to a hydrogen inlet 12a and an air (or oxygen) inlet 14a of the fuel cell stack 10 and then the hydrogen and oxygen containing air (or pure oxygen) after the electrochemical reaction in the fuel cell stack 10 are discharged through a hydrogen outlet 12b and an air (or oxygen) outlet 14b.

The first fuel cell activation process will be described in more detail below.

First, in order to hydrate the inside of the fuel cell 10, the temperature of coolant flowing through a cooling line of the fuel cell 10 is increased to a predetermined level, and the temperature of a humidifier connected to an inlet and an outlet of an air electrode (cathode) of the fuel cell is increased so as to sufficiently humidify oxygen containing air (or pure oxygen) supplied to the air electrode through the air (or oxygen) inlet of the fuel cell.

The reason for this is that sufficient humidification of the catalyst layers and the electrolyte membrane included in a membrane electrode assembly (MEA) of the fuel cell is essential to achieve high performance of the fuel cell. That is, when a polymer electrolyte membrane applied to a fuel cell vehicle is sufficiently wetted with water, ion conductivity is increased to reduce the loss due to resistance; however, if reactant gases having a low relative humidity are continuously supplied, the polymer electrolyte membrane becomes dried eventually and no longer be able to be used as the electrolyte membrane. Accordingly, the humidification of the supplied reactant gases is indispensable to the operation of a polymer electrolyte membrane fuel cell.

With the humidification, hydrogen is supplied to a fuel electrode (anode) through the hydrogen inlet 12a of the fuel cell stack 10 and oxygen containing air (or pure oxygen) is supplied to the air electrode (cathode) through the air (or oxygen) inlet 14a.

Accordingly, when hydrogen as a fuel is supplied to the fuel electrode and oxygen containing air (or pure oxygen) as an oxidant is supplied to the air electrode, the hydrogen supplied to the fuel electrode is dissociated into hydrogen ions and electrons by an oxidation reaction on the catalyst layer. Then, the thus generated hydrogen ions move to the air electrode through the electrolyte membrane and the electrons are transferred to the air electrode through an external circuit. As a result, at the air electrode, the supplied oxygen combines with electrons to produce oxygen ions by a reduction reaction on the catalyst layer, and the hydrogen ions combine with the oxygen ions to produce water, thus generating electricity.

In an embodiment, in the first fuel cell activation process, the fuel cell may be operated under load condition or under no-load condition by varying the amount of the reactant gases supplied to the fuel cell.

Meanwhile, the hydrogen and oxygen containing air (or pure oxygen) after the reaction in the fuel cell stack 10 are discharged through the hydrogen outlet 12b and the air (or oxygen) outlet 14b. The first fuel cell activation process is completed when the cell voltage of the fuel cell reaches a reference cell voltage.

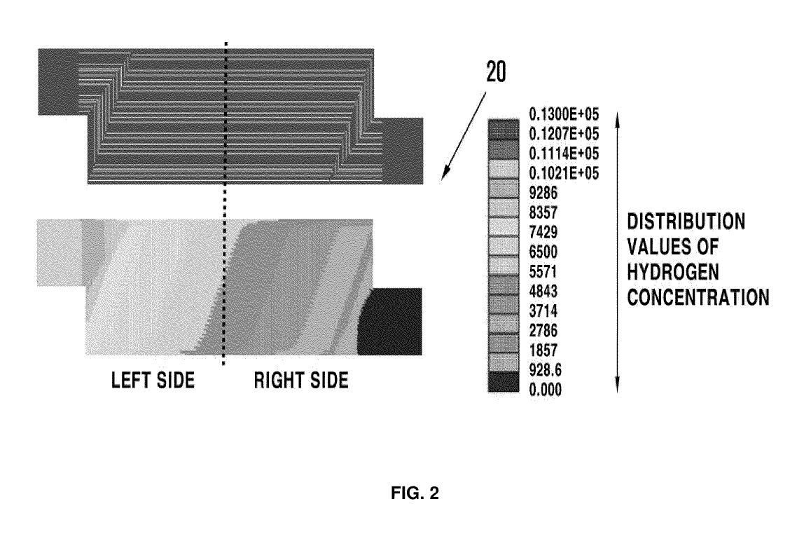

When the fuel concentration of a separator 20 is measured after completion of the first fuel cell activation process, the hydrogen concentration is high and the air (or oxygen) concentration is low at the hydrogen inlet side along the longitudinal direction of the separator 20, whereas the hydrogen concentration is low and the air (or oxygen) concentration is high at the hydrogen outlet side along the longitudinal direction of the separator 20, and thus the concentration distribution of hydrogen and air (or oxygen) is not uniform along the longitudinal direction of the separator 20, as shown in FIG. 2, which means that the activation has not been sufficiently performed.

Accordingly, the second fuel cell activation in accordance with the present invention is performed to improve the initial performance of the fuel cell by making the fuel concentration distribution of the separator uniform.

The second fuel cell activation process is a reverse activation process, performed in such a manner that the fuel cell stack itself is rotated 180° and mounted in the activation equipment.

That is, the fuel cell stack is rotated 180° so that the hydrogen inlet 12a and the air (or oxygen) inlet 14a of the fuel cell are shifted to the hydrogen outlet 12b and the air (or oxygen) outlet 14b, and vice versa, and the second fuel cell activation process is performed in the same manner as the first fuel cell activation process.

As discussed above, the following activation steps are performed in the first and second fuel cell activation processes.

(1) After mounting the fuel cell in the activation equipment, the state of the humidifier and the state of the coolant are first changed so as to accelerate the hydration of the fuel cell.

(2) Hydrogen and air (or oxygen) are supplied to the fuel cell and the fuel cell is operated under no-load condition so as to remove impurities in a gas channel in the inside of the cell and maintain the cell in an equilibrium state.

(3) The fuel cell is operated under load condition by varying the amount of reactant gases supplied to the fuel cell, in which the hydrated state of the cell is maintained and the utilization of hydrogen gas is varied by increasing the amount of reactant gases or increasing the amount of water in the inside of the cell.

(4) The operation condition of the fuel cell is returned to the no-load condition and the minimum amount of hydrogen and air (or oxygen) is resupplied. If the operation condition of the fuel cell is repeatedly changed from the load condition to the no-load condition, and vice versa, the fuel cell is rapidly activated.

(5) Finally, data measured when the fuel cell is operated under no-load condition and data measured when the fuel cell is operated under load condition are compared and, if the cell voltage reaches a reference range, it is considered that the activation is completed.

After completion of the second fuel cell activation process, the hydrogen concentration is low and the air (or oxygen) concentration is high at the hydrogen inlet side along the longitudinal direction of the separator 20, whereas the hydrogen concentration is high and the air (or oxygen) concentration is low at the hydrogen outlet side along the longitudinal direction of the separator 20, and thus it is possible to provide uniform distribution of the hydrogen and air (or oxygen) concentration along the longitudinal direction of the separator 20.

In other words, after the first fuel cell activation process, the hydrogen concentration is high and the air (or oxygen) concentration is low at the hydrogen inlet side, whereas the hydrogen concentration is low and the air (or oxygen) concentration is high at the hydrogen outside side. Under these conditions, the second (reverse) fuel cell activation process is performed so that the hydrogen concentration is low and the air (or oxygen) concentration is high at the hydrogen inlet side, and the hydrogen concentration is high and the air (or oxygen) concentration is low at the hydrogen outside side. As a result, it is possible to provide uniform distribution of the hydrogen and air (or oxygen) concentration along the longitudinal direction of the separator 20.

Accordingly, the hydrogen and air (or oxygen) concentration distribution at the hydrogen inlet and outlet sides after the first fuel cell activation process and that after the second fuel cell activation process are offset relative to each other, and thus it is possible to provide uniform distribution of the hydrogen and air (or oxygen) concentration along the longitudinal direction of the separator 20. As a result, all catalysts of the membrane electrode assembly are activated, and thus it is possible to eliminate the difference in performance according to the positions and maximize the performance of the fuel cell.

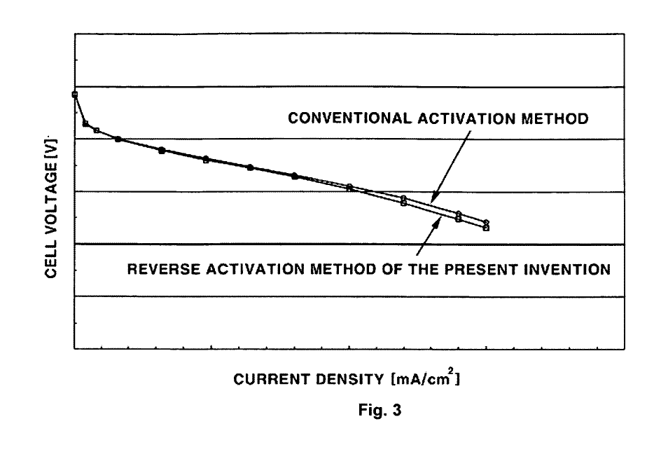

Meanwhile, the cell voltages according to the activation of the fuel cell after completion of the conventional fuel cell activation method and the reverse activation method of the present invention including the first and second (reverse) activation processes were measured and, as a result, it can be seen from the graph of FIG. 3 that the cell voltage according to the present activation method was improved by approximately 5% compared with that of to the conventional method. As described above, the present invention provides the following effects.

With the second fuel cell activation process performed by shifting the hydrogen inlet and the hydrogen outlet of the fuel cell to the air (or oxygen) inlet and the air (or oxygen) outlet of the fuel cell after the first fuel cell activation process, it is possible to make the concentration distribution of hydrogen and air (or oxygen) uniform in the longitudinal direction of the fuel cell separator and thus improve the performance of the membrane electrode assembly.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for reverse activation of a fuel cell, the method comprising the steps of:
(a) supplying a predetermined amount of hydrogen and a predetermined amount of oxygen containing air (or pure oxygen) are supplied to a hydrogen inlet and an air (or oxygen) inlet of a fuel cell, respectively, and discharging hydrogen and oxygen containing air (or pure oxygen) through a hydrogen outlet and an air (or oxygen) outlet, respectively, after electrochemical reaction occurs in the fuel cell; and
(b) supplying hydrogen and oxygen containing air (or pure oxygen) through the hydrogen outlet and the air (or oxygen) outlet, respectively, and discharging hydrogen and oxygen containing air (or pure oxygen) through the hydrogen outlet and the air (or oxygen) outlet, respectively, after electrochemical reaction occurs in the fuel cell.

2. The method of claim 1, wherein each of the steps (a) and (b) is performed in sequential order of:
mounting the fuel cell in equipment for activation;
changing the state of a humidifier for supplying water vapor steam to the fuel cell and the state of coolant;
supplying hydrogen and oxygen containing air (or pure oxygen) to the fuel cell and operating the fuel cell under no-load condition;
operating the fuel cell under load condition by varying the amount of hydrogen and air (or oxygen) supplied to the fuel cell;
returning the operation condition of the fuel cell to the no-load condition and resupplying reactant gases; and
determining whether activation is completed by comparing data measured when the fuel cell is operated under no-load condition with data measured when the fuel cell is operated under load condition.

3. The method of claim 1, wherein, after the step (a), a hydrogen concentration is high and an air (or oxygen) concentration is low at the hydrogen inlet side, and the air (or oxygen) concentration is high and the hydrogen concentration is low at the hydrogen outlet side along the longitudinal direction of a fuel cell separator.

4. The method of claim 1, wherein, after the step (b), the hydrogen concentration becomes uniform along the longitudinal direction of the fuel cell separator by offsetting the hydrogen concentration and air (or oxygen) concentration resulted from the step (a).
